(19) United States
(12) Patent Application Publication
(10) Pub. No.: US 2024/0306219 A1
(43) Pub. Date: Sep. 12, 2024

(54) METHOD AND APPARATUS FOR IMPROVEMENTS IN AND RELATING TO TELECOMMUNICATION SYSTEMS

(71) Applicant: Samsung Electronics Co., Ltd., Suwon-si, Gyeonggi-do (KR)

(72) Inventors: Himke VAN DER VELDE, Staines (GB); Jinwoo OCK, Suwon-si (KR); June HWANG, Suwon-si (KR); Sangbum KIM, Suwon-si (KR)

(21) Appl. No.: 18/271,147

(22) PCT Filed: Jan. 17, 2022
(86) PCT No.: PCT/KR2022/000855

§ 371 Date: Jul. 6, 2023

(30) Foreign Application Priority Data
Jan. 15, 2021 (GB) 2100536.8
Jan. 14, 2022 (GB) 2200432.9

(51) Int. Cl. H04W 76/10; H04W 24/10; H04W 36/36

(52) U.S. Cl. CPC H04W 76/10; H04W 24/10; H04W 36/362

(57) ABSTRACT

The disclosure relates to a 5G or 6G communication system for supporting a higher data transmission rate. A method performed by a user equipment (UE) in a wireless communication system is provide. The method includes receiving, from a first base station, logged measurement configuration information, performing a first connection release procedure with the first base station, transmitting, to a second base station, a first connection setup request message, receiving, from the second base station, a first connection setup message, and transmitting, to the second base station, a first connection setup complete message indicating that a measurement according to the logged measurement configuration information is not completed.

### TECHNICAL FIELD

The present invention relates to telecommunication networks and, in particular, improvements relating to Self-Organising Networks (SON), Minimising Drive Test (MDT) and Conditional reconfiguration in certain circumstances.

### BACKGROUND ART

5G mobile communication technologies define broad frequency bands such that high transmission rates and new services are possible, and can be implemented not only in “Sub 6 GHz” bands such as 3.5 GHZ, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service. Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user con-venience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultrahigh-performance communication and computing resources.

### DISCLOSURE OF INVENTION

### Technical Problem

In relation to SON and MDT, aspects of the invention provide solutions in relation to: avoiding overwriting of logged MDT configuration/discarding of logged MDT results; continuation of logged MDT upon Inter-Radio Access Technology (IRAT) mobility; and reporting of information for SON regarding Conditional Handover (CHO).

In relation to conditional reconfiguration and the signalling aspects thereof, aspects of the invention relate to: signalling to support multiple candidates by single network interface message/procedure; and capability coordination when multiple Secondary Nodes (SNs) are involved e.g. at reconfiguration.

It is an aim of embodiments of the present invention to address issues in relation to the aforementioned areas of activity.

### Solution to Problem

According to the present invention there is provided an apparatus and method as set forth in the appended claims. Other features of the invention will be apparent from the dependent claims, and the description which follows.

In accordance with an aspect of the disclosure, a method performed by a user equipment (UE) in a wireless communication system is provided. The method includes receiving, from a first base station, logged measurement configuration information, performing a first connection release procedure with the first base station, transmitting, to a second base station, a first connection setup request message, receiving, from the second base station, a first connection setup message, and transmitting, to the second base station, a first connection setup complete message indicating that a measurement according to the logged measurement configuration information is not completed.

In accordance with another aspect of the disclosure, A user equipment (UE) in a wireless communication system is provided. The UE includes a transceiver and a controller. The controller is configured to receive, from a first base station via the transceiver, logged measurement configuration information, perform a first connection release procedure with the first base station, transmit, to a second base station via the transceiver, a first connection setup request message, receive, from the second base station via the transceiver, a first connection setup message, and transmit, to the second base station via the transceiver, a first connection setup complete message indicating that a measurement according to the logged measurement configuration information is not completed.

According to a first aspect of the invention, there is provided a method of performing measurement logging, at a User Equipment, UE, for the purpose of Minimising Drive Test, MDT, wherein a relevant configuration is not overwritten in one or more of the following circumstances:
a) when the relevant configuration is not completed; and
b) if a previously configured log MDT configuration is set by a RAN node within the same PLMN, using the same RAT or using another RAT.

In an embodiment, the UE does not accept a log MDT configuration when previously configured with log MDT, set by RAN nodes within the same PLMN or using another RAT, that it considers is not completed.

In an embodiment, the UE provides assistance concerning log MDT configuration that it considers is not completed.

In an embodiment, for a) a determination is made on the basis of one or more of:
i) A logging duration for the log MDT configuration has not expired;
ii) The UE has Log MDT results available;
iii) A combination of the preceding options i) and ii);
iv) signalling based Logged MDT is configured, but no results are available; and
v) Signalling based Logged MDT configuration is stopped but the UE still has un-retrieved results that would be discarded upon accepting a new configuration.

According to a second aspect of the invention, there is provided a method of configuring nodes in a telecommunication employing Multi-Rat Dual Connectivity, MRDC, comprising the step of:
preparing a plurality of PSCells in a single Conditional PSCell Addition and Change, CPAC, procedure whereby the plurality of candidates are either not visible to XnAP by being hidden within RRC inter-node messaging or visible to xnAP by means of a container per candidate cell.

In an embodiment, the plurality of candidates are not visible to XnAP.

According to a third aspect of the invention, there is provided a method of conditional reconfiguration in a telecommunication network employing MRDC, wherein modification of a UE configuration comprises either separate capability coordination for each Secondary Node, SN, or common capability coordination where a Master Node, MN, applies the same SN configuration restrictions for each SN that is involved.

In an embodiment, separate capability coordination for each Secondary Node, SN, involves a separate capability coordination for the Source SN, S-SN, and each one or more Target SN, T-SN.

In an embodiment, a message or procedure in which information regarding a plurality of SNs is transferred; or multiple messages or procedures, each including information regarding a single SN.

According to a fourth aspect of the invention, there is provided a method of controlling UE behaviour in connection with broadcast signalling in a telecommunication network whereby the network broadcasts information relating to a condition which a receiving UE must meet in order to perform a certain feature for which information is broadcast.

In an embodiment, the information broadcast comprises a numerical value, the numerical value relating to a version number, and the version number being related to the feature.

According to a fifth aspect of the invention, there is provided apparatus arranged to perform any one of the aforementioned aspects.

Although a few preferred embodiments of the present invention have been shown and described, it will be appreciated by those skilled in the art that various changes and modifications might be made without departing from the scope of the invention, as defined in the appended claims.

### Advantageous Effects of Invention

According to an embodiment of the present disclosure, Self-Organising Networks (SON), Minimizing Drive Test (MDT) or Conditional reconfiguration in a wireless communication system can be improved.

### BRIEF DESCRIPTION OF DRAWINGS

For a better understanding of the invention, and to show how embodiments of the same may be carried into effect, reference will now be made, by way of example only, to the accompanying diagrammatic drawings in which:

FIG. 1 shows a message flow where a UE provides assistance indicating that it has an incomplete logged MDT transaction, according to an embodiment of the invention;

FIG. 2 shows a message flow relating to Logging in the context of Conditional Handover, according to an embodiment of the present invention;

FIG. 3 shows a message flow relating to inter-node signalling for inter-SN CPC, according to an embodiment of the present invention.

FIG. 4 illustrates an electronic device according to embodiments of the present disclosure; and

FIG. 5 illustrates a base station according to embodiments of the present disclosure.

### MODE FOR THE INVENTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

It is known to those skilled in the art that blocks of a flowchart (or sequence diagram) and a combination of flowcharts may be represented and executed by computer program instructions. These computer program instructions may be loaded on a processor of a general purpose computer, special purpose computer, or programmable data processing equipment. When the loaded program instructions are executed by the processor, they create a means for carrying out functions described in the flowchart. Because the computer program instructions may be stored in a computer readable memory that is usable in a specialized computer or a programmable data processing equipment, it is also possible to create articles of manufacture that carry out functions described in the flowchart. Because the computer program instructions may be loaded on a computer or a programmable data processing equipment, when executed as processes, they may carry out operations of functions described in the flowchart.

A block of a flowchart may correspond to a module, a segment, or a code containing one or more executable instructions implementing one or more logical functions, or may correspond to a part thereof. In some cases, functions described by blocks may be executed in an order different from the listed order. For example, two blocks listed in sequence may be executed at the same time or executed in reverse order.

In this description, the words “unit”, “module” or the like may refer to a software component or hardware component, such as, for example, a field-programmable gate array (FPGA) or an application-specific integrated circuit (ASIC) capable of carrying out a function or an operation. However, a “unit”, or the like, is not limited to hardware or software. A unit, or the like, may be configured so as to reside in an addressable storage medium or to drive one or more processors. Units, or the like, may refer to software components, object-oriented software components, class components, task components, processes, functions, attributes, procedures, subroutines, program code segments, drivers, firmware, microcode, circuits, data, databases, data structures, tables, arrays or variables. A function provided by a component and unit may be a combination of smaller components and units, and may be combined with others to compose larger components and units. Components and units may be configured to drive a device or one or more processors in a secure multimedia card.

Prior to the detailed description, terms or definitions necessary to understand the disclosure are described. However, these terms should be construed in a non-limiting way.

The “base station (BS)” is an entity communicating with a user equipment (UE) and may be referred to as BS, base transceiver station (BTS), node B (NB), evolved NB (eNB), access point (AP), 5G NB (5GNB), or gNB.

The “UE” is an entity communicating with a BS and may be referred to as UE, device, mobile station (MS), mobile equipment (ME), or terminal.

Firstly, in relation to MDT, a User Equipment (UE) that is in an idle or inactive mode may be configured to perform measurement logging for the purpose of Minimising Drive Test (MDT). This is referred to as “logged MDT”. Typically the UE performs periodic logging of the measurements it has available, but in New Radio (NR), the UE can also be configured to log measurements of particular events e.g. when an “Out Of Service” condition is met.

Some constraints can be defined regarding when the UE should perform logging e.g. for a limited duration or only when in a particular area (i.e. when camping on a cell that is part of an area that the network can specify as part of the MDT configuration).

It is furthermore possible for the network to specify constraints regarding what the UE shall log. In prior art Long Term Evolution (LTE) networks for example, the UE can be configured to log particular Multimedia Broadcast Multicast Services (MBMS) results for a particular frequency.

In an NR network, the network can also configure a list of neighbouring frequencies for which the UE should log results. When the UE does not have results for the target frequency, the UE behavior is different in LTE and NR. In LTE, the UE omits a periodic logging entry while in NR, the UE still adds a logging entry even if this only includes results of the serving cell.

There are two different types of logged MDT i.e. signalling and management based. Signalling based MDT applies when the Core Network (CN) indicates a particular UE for which information is to be collected i.e. by International Mobile Subscriber Identity (IMSI), International Mobile Equipment Identity—Software Version (IMEI-SV), etc. Otherwise, the RAN selects the UEs for collecting measurements (management based). In the latter case, the RAN can configure many UEs and it is not a significant problem if a particular UE cannot provide the requested info e.g. due to an In Device Coexistence (IDC) problems it may have experienced.

Network signalling and overall control of MDT is described in the standards specification referred to by TS 32.422. It seems that the request can include a list of Public land mobile networks (PLMNs), an area and a list of measurement types that can be one of following:
M1 (by UE): Reference Signal Received Power (RSRP) and Reference Signal Received Quality (RSRQ) measurements;
M2 (by UE): Power Headroom measurements;
M3 (by RAN node): Received Interference Power measurements;
M4 (by RAN node): Data Volume measurements for Downlink (DL) and Uplink (UL), per Quality-of-Service Class Identifier (QCI) per UE;
M5 (by RAN node): Scheduled IP Throughput, per Radio Access Bearer (RAB) per UE and per UE for the DL, per UE for the UL;
M6 (by UE and RAN node): Packet Delay measurement, separately for DL and UL, per QCI per UE;
M7 (by RAN node): Packet Loss rate measurement, separately for DL and UL per QCI per UE;
M8 (by UE): Received Signal Strength Indicator (RSSI) measurement by UE; or
M9 (by UE): Roundtrip time (RTT) measurement by UE

For some of these measurement types (e.g. M1, M8), the RAN should provide results per frequency. The RAN may configure measurements on one or more frequencies and it should be noted that it is up to the RAN to decide which one or more frequencies, as the request from the CN does not include any information regarding frequency. It is noted that for MBMS, the target frequency can be included in the request but this is regarded as exception.

The following relates to avoiding overwriting of Signalling-based Logged MDT in other RAT(s).

There are some general principles which have been agreed for logged MDT.

Firstly, if the network has configured Log MDT, any previous configuration is overwritten.

Secondly, the UE reports availability of log MDT upon entering connected setupComp, resumeComp, reconfigComp (includes Handover (HO) to NR), reestablishComp (e.g. by NR: UE-MeasurementsAvailable-r16), upon which the network may retrieve the information.

Thirdly, the network is not aware if timer T330 has expired (but might be able to infer something in relation to this e.g. from retrieved information). This was not essential in the prior art i.e. the network can simply re-assign new configuration, if desired, and the UE overwrites if T330 expires.

Fourthly, logged measurement results are discarded in the following circumstances:
48 hrs after T330 expiry
Upon overwriting either in the same or in another RAT
Upon power off or detach

Note that T330 is started upon receiving LoggedMeasurementConfiguration

When introducing logged MDT for NR in release 16, it was agreed to re-use most of these general principles. As an exception, it was however agreed that a signaling based logged MDT (sig-Log MDT) configuration should not be overwritten following mobility to another RAT. It was furthermore agreed that a network, rather than a UE, based mechanism, should be adopted to avoid such MDT configuration being overwritten. Such mechanism may comprise the following steps. Upon UE mobility, the source node indicates to the target node whether the UE is configured with sig-Log MDT (and possibly some more e.g. end time). The same kind of information should be transferred upon IRAT change (intra-PLMN). This is needed because when the UE returns to the source RAT before the logging duration (timer) expires, it should resume sig-Log MDT.

However, there were some issues identified with a network based solution referred to above. A network based mechanism was discussed which sought to avoid the case where a signalling based mechanism was overwritten, and this identified several possible issues.

Some contributors thought that a network based approach is not feasible for idle mode, because for UEs in idle mode, the RAN does not store a UE context in which this configuration state could be maintained. Other contributors thought that a network based approach can still be introduced, but that it should be limited to inactive mode. This may imply that the network should move a UE to inactive, rather than to idle, if the UE is configured with a signalling based MDT configuration.

For cases without a direct interface between source and target node, the solution involves a more significant change, as UE context for MDT is currently neither stored by CN nodes nor included in UE context as exchanged between a) RAN and CN, b) inbetween CN nodes.

Note that the Trace Collection Entity (TCE) can avoid that a first sig-Log MDT overwrites another one by ensuring that the second is issued only some time after the first is completed. For management based logged MDT (mgmt-Log MDT), it is the RAN that selects the UE, so it is the RAN's responsibility.

It is understood that it was not possible to conclude a way forward (i.e. there was no consensus among the contributors to only have a solution for inactive). Hence this issue may need to re-discussed. One or both of the following options may require consideration:
a) Discuss whether it is acceptable to have a network based solution only supporting inactive. I.e. evaluate if it is acceptable for UEs to be moved to inactive rather than to idle. Although this may increase UE battery consumption somewhat, this may be fine provided it is rather infrequent
b) Re-consider use of a UE based mechanism

There are certain issues to consider regarding when to avoid overwriting. It is thought that the UE may have logged MDT measurement results stored regardless of whether it is (still) configured with the associated logged MDT i.e. the following cases are possible:
1) Logged MDT configuration is released, but the UE still has un-retrieved results that would be discarded upon accepting a new configuration.
2) Logged MDT is configured, but no results are available because, for instance, so far nothing is stored, or all the previously stored results have been retrieved.

In case 1) above, it is preferable to avoid overwriting and the associated data loss. In case 2) above, there may be no strong need to avoid overwriting. On balance, it is considered that modification of the requirement can result in some improvements. Solutions may also be provided to prevent overwriting of other cases than initially foreseen. In other words, solutions need not be limited to preventing overwriting of sig-Log MDT by mgmt.-Log MDT. For instance, if the UE moves to another RAT, it may be preferable to not select a UE for management based MDT if that UE still has unretrieved log MDT results stored.

In a first embodiment, overwriting of a log MDT configuration, possibly set by another RAT, is to be avoided whenever a concerned configuration is not completed, which includes the following cases:

The logging duration for the log MDT configuration (associated timer) has not expired
1. The UE has Log MDT results available i.e. results were stored and not yet retrieved (this can happen even though timer has expired)
2. A combination i.e. Log MDT still ongoing and/or (unretrieved) logging results are available

Further, signalling based logged MDT override protection is applicable in the following scenarios:
1) Signalling based Logged MDT is configured, but no results are available e.g. so far nothing stored, or all previously stored results retrieved; or
2) Signalling based Logged MDT configuration is stopped (i.e. Timer T330 has expired), but the UE still has un-retrieved results that would be discarded upon accepting a new configuration;
This embodiment may include an indicator to indicate the signalling based logged MDT configuration availability in one or more of RRCSetupComplete/RRCConnectionSetupComplete and RRCResumeComplete/RRCConnectionResumeComplete.

In a second embodiment, firstly, overwriting avoidance can be used in case a previously configured log MDT configuration is set by the RAN node within the same PLMN using the same RAT (e.g. upon return to/from idle) or using another RAT (e.g. upon IRAT mobility). Secondly, overwriting avoidance of an (IRAT) log-MDT configuration can be used for any combination of: (IRAT) log MDT previously configured may concern sign-Log MDT or mgmt-Log MDT; log MDT configuration intended to be newly assigned by current RAN node may concern mgmt-Log MDT or sign-Log MDT; and it includes main case i.e. overwriting of (IRAT) sig-Log MDT by mgmt-Log MDT.

In a third embodiment, an option is introduced where the UE may not accept log MDT configuration when previously configured with log MDT, set by RAN nodes within the same PLMN and possibly using another RAT, that it considers is not completed in accordance with the first embodiment above and for cases defined by the second embodiment above.

Further, if the UE ignores Log MDT configuration, it provides failure indication e.g. by sending a FailureInformation message including a specific failure cause. When providing a log MDT configuration, the network provides a configuration defining which IRAT log MDT configuration cases received within the same PLMN should be accepted or rejected by the UE i.e. the network configures for which cases the UE should consider that overwriting is allowed.

In a fourth embodiment, an option is introduced where the UE provides assistance concerning (IRAT) log MDT configuration that it considers is not completed in accordance with the first embodiment above and for cases defined by the second embodiment above. Note, that IRAT is exemplary and an embodiment of the invention is generally applicable i.e. not only to IRAT.

The following are options regarding when the UE provides the concerned assistance:
Upon transition to connected. I.e. same cases as for reporting availability of log MDT i.e. in setupComp, resumeComp, reconfigComp (includes HO to NR), reestablishComp. E.g. by extension of IE UE-MeasurementsAvailable (NR case)
In UEInformationResponse (e.g. if overwrite is acceptable, when no data)
Upon change e.g. upon completion of a previously configured log MDT configuration
Following SPCell/node change, UE repeats if assistance was provided less than 1 s before such node change

The UE assistance can be transferred from source to target node, including the following options:
Source includes assistance in messages sent to target node upon change of RAN node
Target node can request a previous source node to provide the UE assistance
The information may be transferred regardless of whether the source and target nodes are connected by a direct inface

The network can indicate whether the UE is allowed to provide the network assistance using one of the following options:
By an indication in broadcast signalling (i.e. in a System Information Block (SIB)), or
Within dedicated signalling (e.g. by a field within OtherConfig)
The network can use dedicated signalling only if the UE indicates support for the concerned feature.

The following sets out some further examples merely to illustrate certain aspects described in the foregoing.

In a first example, the following Table 1 provides an overview of cases in which sig-Log MDT is completed/ongoing and/or concerned measurement results are available and then reviews, for each such case, whether overwriting of Sig-Log MDT by Mgmt-Log MDT is desirable.

TABLE 1

| | logMDT | | |
|---|---|---|---|
| s-LogMDT | results | | |
| ongoing | available | Configure m-LogMDT? | Configure s-LogMDT? |
| No | No | Yes (overwriting of m- | Yes (s-LogMDT can always |
| | | LogMDT is fine as this will | overwrite m-LogMDT) |
| | | not result in discarding of | |
| | | results) | |
| Yes | No | No; not allowed according | Possibly (overwriting of s- |
| | | to agreement | LogMDT may be fine as this will |
| | | | not result in discarding of |
| | | | results) |
| No | Yes | Yes, but seems best to delay. | Yes, but seems best to delay. I.e. |
| | | I.e. first retrieve results and | first retrieve results and next |
| | | next configure and overwrite | configure and overwrite m- |
| | | m-LogMDT | LogMDT |
| Yes | Yes | No; not allowed according | Possibly, but seems best to delay. |
| | | to agreement | I.e. first retrieve results and next |
| | | | configure and overwrite s- |
| | | | LogMDT |

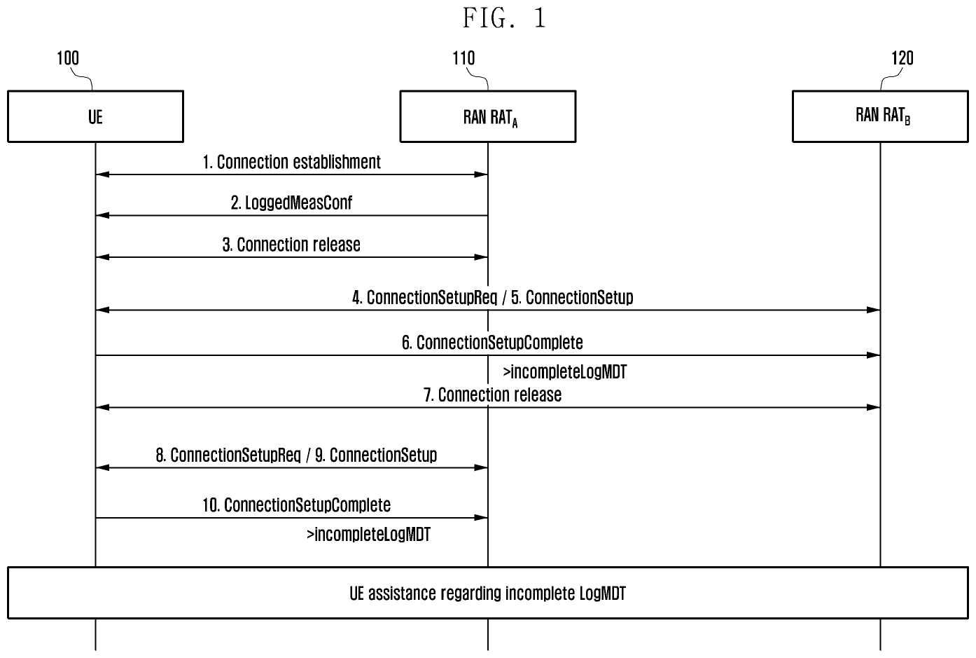

In a second example, illustrated in FIG. 1, there is shown a case in which the UE provides assistance, indicating that it has an incomplete logged MDT transaction i.e. a transaction that is not completed in accordance with the previous.

The steps shown in the figure are:
1. Connection between UE 100 and RAN RAT A 110 is established
2. When connected to a RAN node of the first RAT (RAT_{A}) 110, the UE 100 receives the logged measurement configuration
3, 4, 5: The UE 100 enters idle mode and performs inter-RAT re-selection, entering RAT_{B} 120
6. During connection setup to the RAN node of a second RAT (RAT_{B}) 120, the UE 100 indicates that it has a logged measurement transaction that is not completed. This indication may include an indicator to indicate the signalling based logged MDT configuration availability in RRCSetupComplete/RRCConnectionSetupComplete and RRCResumeComplete/RRCConnectionResumeComplete.
7, 8, 9: The UE 100 enters idle mode and performs inter-RAT re-selection, returning to RAT_{A} 110
10. During connection setup to a RAN node of the first RAT (RAT_{A}), the UE indicates that it has a logged measurement transaction that is not completed

A network based approach means that the UE cannot be moved to idle when certain log MDT configurations are not completed. An approach in which the UE does not accept a logged MDT configuration is considered to be simplest to implement. However, it deviates from the general principle that network is required to always configure the UE correctly. An approach in which the UE provides assistance involves somewhat more changes and/or somewhat more complexity, but it is considered preferable as it avoids deviating from the general principle.

There have been proposals to enhance support of logged MDT upon inter-RAT mobility by introduction of a first option to continue an MDT measurement logging following IRAT reselection e.g. by extending the validity area to include IRAT cells/frequencies or by, a second option introducing support of per RAT logged MDT configuration, operating independently, so when camping in NR, the UE applies procedures according to configuration assigned by NR (performing logging, reporting availability, responding to retrieval requests)

These proposals above merely enhance MDT measurement logging for camping frequencies. For management based logged MDT, results from a large number of UEs can be combined i.e. results from UEs in RAT1 and in RAT2. Moreover, although IRAT mobility may be somewhat more frequent due to more spotty coverage of NR, it is not clear how significant this is in practice i.e. as smaller cell sizes do not necessarily imply smaller coverage areas and increased IRAT mobility. NR may be used to provide coverage for an entire shopping mall as before.

However, continuation of logged MDT upon IRAT mobility (as in the first option above) will ensure good measurement results at IRAT mobility and at boundaries of coverage for individual RATs.

The first option above is considered to be most consistent with existing principles and it seems simplest to introduce. The second option above seems more of a radical change and more complex, in particular when at some point in time it is not possible anymore to maintain full independence between the per RAT configurations.

Thus far this enhancement has not been implemented, so it is unclear if there is sufficient motivation to introduce it in a future release. If considered essential, solutions minimising UE complexity are most likely to be adopted.

For the first option above, it has been proposed to extend the validity area to include IRAT cells. Such a solution only works in case a validity area, that is optional to configure, is configured by the network. The solution should, however, also cover the case in which a validity area is not configured by the network.

In an embodiment, the RRC message LoggedMeasurementConfiguration is extended by adding a field indicating that, if no validityArea is configured, the UE should continue logging on any cell of a given target RAT. To support continuation towards multiple RATs, the field may indicate a set of RATs for which continued measurement logging applies.

In the following some further examples are provided merely to illustrate the embodiments described in the previous passages.

The following Tables 2 and 3 illustrate some signalling changes that may be introduced to support the feature.

TABLE 2
LoggedMeasurementConfiguration-r16-IEs ::= SEQUENCE {
traceReference-r16 TraceReference-r16,
traceRecordingSessionRef-r16 CTET STRING (SIZE (2)),
tce-Id-r16 OCTET STRING (SIZE (1)),
absoluteTimeInfo-r16 AbsoluteTimeInfo-r16,
areaConfiguration-r16 AreaConfiguration-r16 OPTIONAL, --Need R
plmn-IdentityList-r16 PLMN-IdentityList2-r16 OPTIONAL, --Need R
bt-NameList-r16 SetupRelease {BT-NameList-r16} OPTIONAL, --Need M
wlan-NameList-r16 SetupRelease {WLAN-NameList-r16} OPTIONAL, --Need M
sensor-NameList-r16 SetupRelease {Sensor-NameList-r16} OPTIONAL, --Need M
loggingDuration-r16 LoggingDuration-r16,
reportType CHOICE {
periodical LoggedPeriodicalReportConfig-r16,
eventTriggered LoggedEventTriggerConfig-r16,
...
},
lateNonCriticalExtension OCTET STRING OPTIONAL,
nonCriticalExtension LoggedMeasurementConfiguration-v17xy-IEs OPTIONAL
}
LoggedMeasurementConfiguration-v17xy-IEs ::= SEQUENCE {
continueInterRAT-List-r16 SEQUENCE(SIZE (1..maxFreq)) OF RAT-Type
OPTIONAL -- Need R
nonCriticalExtension SEQUENCE { } OPTIONAL
}

TABLE 3
LoggedMeasurementConfiguration field descriptions

continueInterRAT-ListIndicates that UE continues logged MDT upon performing
Inter-RAT re-selection to a cell of the concerned RAT types. Network only indicates
RAT by this field for which it does not configure a validity area by field interRAT-
TargetList.

Another way to indicate IRAT continuation may be by specifying an empty interRAT-TargetList e.g. a frequency list with size 0, as following Table 4:

TABLE 4
ratX-TargetFreqList-r17 SEQUENCE(SIZE (0..maxFreq)) OF TargetFreqInfoRATX-
r17 OPTIONAL -- Need R

Without this additional indication, as set out above, it is not possible to support IRAT continuation without specifying a validity area.

In release 16 of the LTE and NR standards, enhancements were introduced regarding the handling of UE mobility. One such enhancement concerns the definition of a conditional reconfiguration i.e. a reconfiguration that is configured at a moment of time, T1, but performed or executed only at a later moment, T2, when a corresponding condition is met. Such conditional configuration has been defined for change of PCell (referred to as Conditional Handover or CHO) as well as for change of PSCell (referred to as Conditional PSCell Change, CPC). The mechanism was introduced to cope with quick degradation of radio conditions as a result of which it may not be possible for UE to transfer a Measurement Report message, or for network to transfer a mobility related reconfiguration in response.

For the case of CHO, the target node provides the configuration that the UE shall apply when the condition is met i.e. at time T2 (execution). Such a configuration is defined by a field condRRCReconfig that defines (for the CHO case) the target PCell configuration. More precisely, the field carries the reconfigurations the UE shall perform relative to the current (source) PCell configuration. It was further agreed that when performing Reestablishment, the UE may initiate CHO execution for a candidate that is suitable and for which attemptCondReconfig is set.

In release 16, there was introduced the baseline SON/MDT procedures for NR. Currently further enhancements are being considered. Some of these enhancements concern radio link and handover failure. Furthermore, consideration is being given to the reporting of successful handover. Some of these enhancements are particularly relevant for the case of CHO and embodiments of this invention particularly address this area.

In case of radio link or handover failure, the UE provides information related to time of failure, identities of relevant cells, type of failure and available measurements applicable at the time of failure. The network typically configures the UE to trigger a Measurement Report message when certain conditions are met, reflecting that a better cell is available. The condition that triggers the UE to send the MR message is referred to as the measurement event.

The measurement procedures are quite flexible and include many different options, such as the network can configure multiple measurements, each using a different event, and trigger HO depending on what UE reports for the set of measurements. A further option is that the network can configure the UE to periodically provide a MR message after an event condition is met i.e. the so called event triggered reporting.

The SON/MDT procedures planned to be introduced should enable the network to optimise the CHO configurations. However, it is so far not defined what (measurement) information the UE can provide to assist this. The information should enable the network to optimise various aspects related to which candidates to configure and what conditions correspond to this, including: which of the configured candidates were not needed or useful and merely resulted in a waste of reserved network resources and increase of the measurement burden on the UE; and which neighbouring cells would have been good candidates, that would have improved CHO robustness and/or avoided failure of CHO (CHOF).

When configuring a UE to with one or more CHO candidates, the network can configure the UE to perform measurement logging. If configured to perform CHO related measurement logging, the UE logs available measurement results while evaluating CHO candidates. The measurement logging may continue for some time after CHO execution.

The network can provide several configuration options. These are set out below.

The network can configure whether to log results once (one shot), periodically or to log results only if a specific event occurred and, depending on the option selected, the further relevant details e.g. interval, which events or event specifics (e.g. offset, threshold).

It can configure for which duration to store results e.g. by indicating the time window relative to the time CHO execution is triggered and with the option to include results logged before and after that moment.

It can configure criteria based on which UE can determine whether (some of) the logged measurement results should be kept and reported to network or whether these may be discarded. e.g. clearing may apply in case CHO succeeded and results were not very useful, such as no good neighbours spotted that should have been configured, very stable/unsurprising.

It can configure settings regarding what results the UE should report e.g. regarding frequencies, cells as well as regarding what information to provide for each e.g. quantities, neighbouring cells.

When reporting availability, the UE may provide further details regarding the results it has logged, such as information reflecting the amount of information stored (e.g. duration covered, amount of cells) or information reflecting the relevance (e.g. whether results are particularly interesting, suggest particular events may have occurred, etc.).

The availability reporting may be done within the ReconfigurationComplete used to confirm successful completion of CHO or by another message sent at a later time i.e. after the logging of CHO information has completed.

The CHO related information is retrieved by the UE information procedure. Some additional fields are introduced to request and transfer the CHO related information.

In a first embodiment, the network configures the UE to provide measurement results valid at CHO execution time, including results for the best cells on the frequencies that the UE is measuring (i.e. results at one particular moment i.e. once/one-shot).

The Frequencies may be limited to frequencies measured for CHO evaluation. The reported cells may be limited to include: neighbouring cells, possibly limited to those not configured as CHO candidate, that are above a certain threshold (threshold1); CHO candidates above a certain threshold (threshold2) or below a certain threshold (threshold3), noting that threshold2 need not be different from threshold1.

Note that results may be absent. In other words the UE may just report list of cells for which reporting condition is met e.g. above a certain threshold.

In a second embodiment, the network configures the UE to provide measurement results periodically logged while evaluating CHO and until a given time after CHO execution. The network may configure how long the UE continues logging after CHO execution. This may be done implicitly by the timer used to monitor CHO failure i.e. T304. If a separate timer is used, the UE may abort prematurely if CHO failure is detected before. The network may configure the time window before CHO execution. In such case, the UE may discard results that were logged before. With regard to the contents of the report provided to network, the same applies as in the first embodiment above.

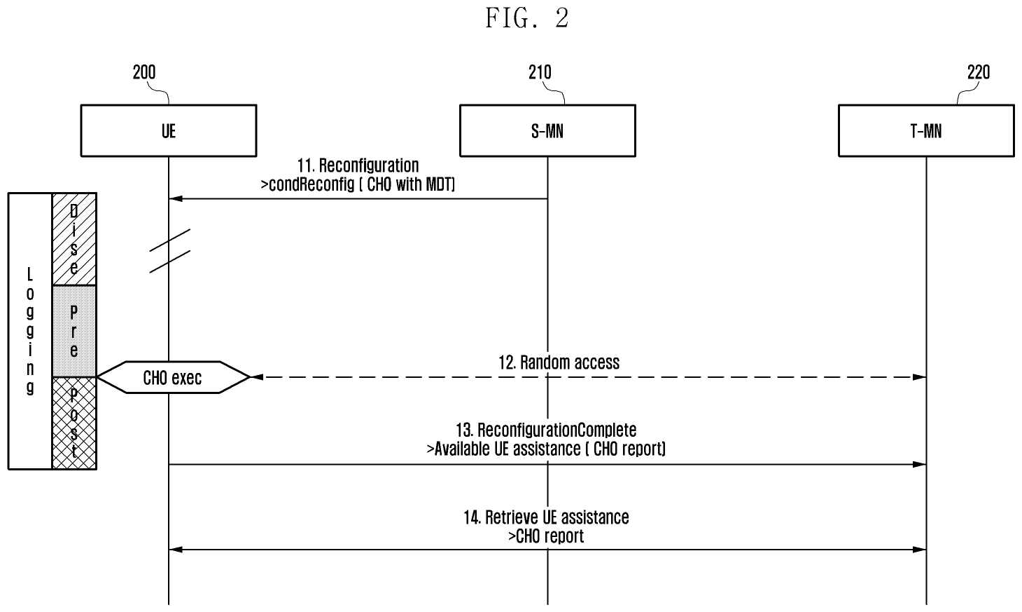

A third embodiment is illustrated in FIG. 2, which shows possible sequence of events.

There follows a description of the steps illustrated in the figure, which illustrates the interactions between UE 200, Source Master Node (S-MN) 210 and Target Master Node (T-MN) 220.
11: The UE is configured with CHO candidates and is instructed to periodically log CHO related measurement results. In this case the network indicates that the UE 200 should provide results that fall within a limited time window, which is some time prior to the moment it triggers CHO execution (referred to as TO) and some time after that same TO. As shown in the figure, the UE 200 logs results following receipt of the command, discards obsolete results and keeps some results covering the indicated time window (see “Pre” and “Post” in the figure, indicating when logging occurs).
12: When CHO conditions are met, the UE 200 initiates random access on the target MN 220, controlling the CHO candidate (according to current standards).
13: When the UE 200 indicates ReconfigurationComplete to indicate successful completion of the CHO, it indicates availability of logged MDT information concerning the CHO. An alternative message may be used for this, as logging may not have completed yet when the UE initiates transfer of this message.
14: The network retrieves the MDT concerning the CHO that the UE 200 stored using the conventional UE information request/response procedure. Some additional fields are introduced to request and transfer the CHO related information.

By this method, information is available by which the network can perform SON for CHO related configuration aspects. The solution illustrated in this invention provides a flexible mechanism providing means for the network to obtain information so it may configure UE to provide for non-conditional HO. The solution involves limited complexity as it is based on existing techniques, although implemented in a different fashion, offering the advantages set out above.

In case a UE is configured with Dual Connectivity, the UE is connected via a Master Cell Group (MCG) to a Master Node (MN) and a Secondary Cell Group (SCG) to a Secondary node (SN). Each node sets the parameters for the cell group it controls, but the nodes interact to ensure that UE capabilities are respected.

There are several different cases of Dual Connectivity, including cases in which MCG and SCG use a different Radio Access Technology i.e. the UE can be configured with an MCG using LTE and an SCG using NR. Embodiments, in particular, address DC cases for which one of the cell groups uses NR. The general term Multi RAT Dual Connectivity (MR-DC) is herein used to refer to these DC cases. This is intended to include the case of NR DC i.e. with both MCG and SCG using NR.

MRDC was introduced in 3GPP release 15 (REL-15 or R15). Some important procedures related to MRDC concern PSCell/SCG or SN addition, involving initial setup of a secondary cell group. An SCG comprises a PSCell and possibly with one or more additional SCells all controlled by the same SN. Further, PSCell change, which may or may not involve change of SN i.e. intra or inter-SN PSCell change, also referred to as SN change.

In 3GPP release 16, conditional reconfiguration was introduced. In this case, the UE is, at time T1, configured with a reconfiguration and a condition. If, at time T2, the condition is fulfilled, the UE executes the reconfiguration. This was mainly introduced for mobility robustness, as the radio link quality may degrade so quickly that it is impossible for the UE to send a measurement report message or for the network to send a Reconfiguration message in response (i.e. transfer of concerned messages may fail).

In R16, conditional reconfiguration was introduced for 2 cases:
a) CHO: Conditional handover i.e. change of PCell (may involve change of MN)
b) Intra SN SI-CPC: SN initiated conditional PSCell change while SN remains unchanged

In R17, specifications have been extended to cover additional conditional reconfiguration cases, in particular covering:
a) SN initiated Change of PSCell involving change of SN
b) MN initiated Change of PSCell (CPC), which always involves change of SN
c) PSCell addition (CPA), which is always initiated by MN

Discussion focused on case a) and it was, in principle, agreed that the MN builds the final message in this case. Some contributors indicated this is acceptable only if inter-node procedures only include a single candidate (as in R16). The main concern was that other approaches may result in deviation from the general principle that the MN need not comprehend SN generated SCG related configuration for the UE, which it should merely forward transparently. It should be noted that this topic was discussed in previous meetings, which can be summarised as in order to support multiple candidate PSCell preparation in Conditional PSCell Addition and Change (CPAC), there are two alternatives: Option 1-prepare one PSCell in one CPAC procedure, use parallel CPAC procedures to prepare multiple PSCells; Option 2-prepare multiple PSCells in one CPAC procedure. In summary, there was a preference for Option 2. Work has therefore focused on Option 2 and in particular how to prepare multiple PSCells in one CPAC procedure.

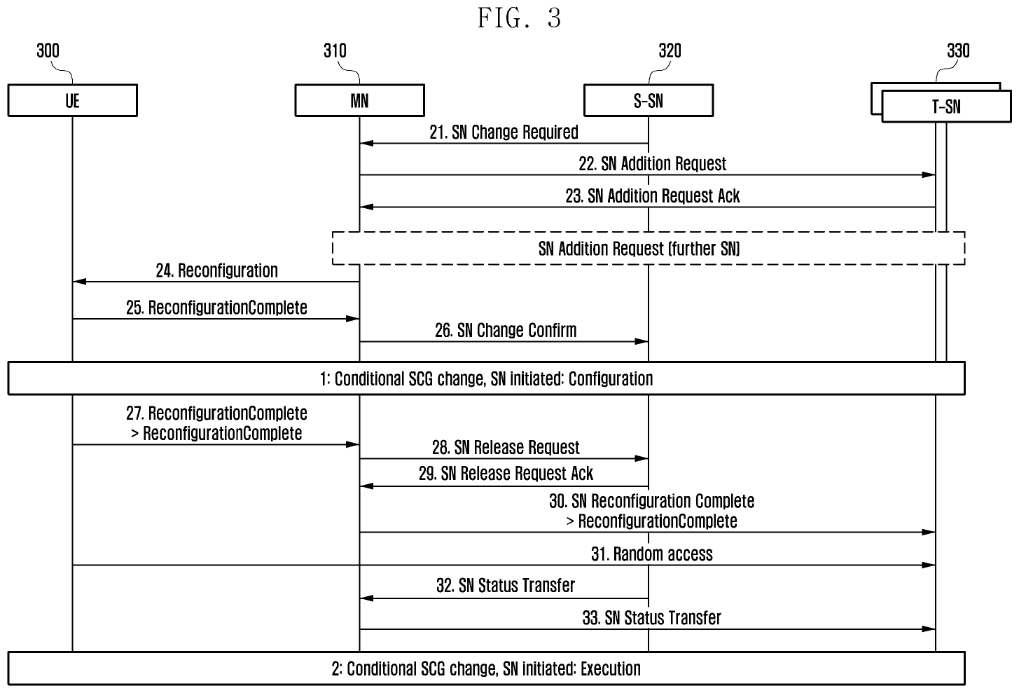

In an embodiment, a variant of option 2, above, that does not violate the general principle regarding MN comprehension/transparent forwarding, is presented. FIG. 3, which shows Inter-node signalling for SN initiated SN change (inter-SN CPC), provides an overview of the message sequence taking into account the agreement regarding MN generation.

The steps shown in FIG. 3 may be grouped into two main groups: steps 21 to 26 which relate to Conditional SCG change, SN initiated: Configuration; and steps 27 to 33 which relate to Conditional SCG change, SN initiated: Execution.

Below are some remarks regarding the existing signalling, as used for non-conditional change of SN. SN change required includes no Xn Application Protocol (XnAP) (per) candidate PSCell specific fields. There are mainly fields indicating the identity of the involved nodes. The message includes a container for the RRC inter-node message (INM), that carries a (single) CG-ConfigInfo message. The RRC INM includes a list of cells that S-SN considers to be suitable PSCell candidates with for each Absolute Radio-Frequency Channel Numbe (ARFCN) of the Reference Signal (RS) (SSB and/or CSI-RS) and measurement results (both cell and beam, SSB and/or CSI-RS based). The RRC INM can carry separate lists based on MN and SN configured measurement, but in this case, it would merely contain the list based on SN configured measurements.

With regard to PSCell candidates, the contents of the SN addition request is the same as for SN change required i.e. multiple candidate cells are merely visible within the (single) CG-ConfigInfo RRC INM, embedded within a container.

The SN addition request includes a CG-Config RRC (INM), embedded within a container, that the SN may use to configure one or more SCG cells. The SN change confirm does not include any RRC INM.

Supporting multiple candidates in CPC preparation has several advantages, but would, according to options discussed so far, violate this general principle regarding MN comprehension and transparent forwarding. Some advantages include that the Target SN has proper overview of potential candidates which will improve admission control it performs i.e. when aware there are other good candidates available, T-SN may decide to refuse candidates on the most loaded frequency (while T-SN may accept these candidates if such good alternative candidates were not available).

An embodiment, based on the second option referred to above, is presented which supports multiple candidates per message, as set out below. There are two different ways to support multiple candidates per XnAP message. In a first sub-option, multiple candidates are not visible to XnAP i.e. hidden within RRC inter-node signalling and in a second sub-option, multiple candidates are visible to XnAP i.e. within XnAP the RRC inter-node information is transferred per candidate (container per candidate).

In the first sub-option, the information regarding which candidates are admitted or refused is not visible at XnAP level, but only hidden within an RRC container generated by T-SN. This means that to build the final message for the UE, the MN needs to decode/comprehend both the T-SN generated RRC container and the S-SN generated container. The following Table 5 describes the two sub-options, based on Option 2, in more detail.

TABLE 5

| Message | First sub-Option | Second sub-Option |
|---|---|---|
| SN change | Existing (single) CG-Config | An XnAP field is added, including |
| required | RRC INM used for multiple | for each (additional) PSCell |
| | candidatesA field may be added to | candidate suggested by initiating |
| | CG-Config, indicating for each | node: |
| | PSCell candidate (embedded in | Identity of PSCell candidate |
| | octet string) | Trigger condition, embedded in |
| | | octet string (RRC encoed inter node |
| | | info) |
| | | Measurement information may be |
| | | provided by existing CG-ConfigInfo |
| | | RRC INM i.e can also cover SCG |
| | | SCells |
| SN addition | Includes single CG-Config, but | An XnAP field is added, including |
| request | additional field containing trigger | for each (additional) PSCell |
| | conditions would be removed by | candidate suggested by initiating |
| | MN | node: Identity of PSCell candidate |
| | | Measurement info: see SN change |
| | | required |
| SN addition | Existing (single) CG-Config | An XnAP field is added, including |
| request ack | RRC INM used for multiple | for each (additional) PSCell |
| | candidatesFields may be added to | candidate that is admitted: |
| | CG-Config, to carry T-SN | Identity of PSCell candidate |
| | generated Reconfiguration of | T-SN generated Reconfiguration |
| | each (additional) PSCell | |
| | candicate that is admitted | |
| | candidates. | |
| | Alternatively, a new INM | |
| | (CG-candidateList in RRC) is | |
| | introduced to include the accepted | |
| | PSCell candidate list. | |
| SN change | An RRC INM may be included | XnAP field may be added indicating |
| confirm | and newly defined indicating the | the PSCell candidates that are |
| | PSCell candidates that are | admitted or refused |
| | admitted or refused | |

It is believed that the decoding of S-SN and T-SN generated/encoded RRC INM, as required in the first sub-option, may violate the general principles regarding IRAT comprehension in MRDC.

The second sub-option involves considerable changes to existing XnAP procedures i.e. it introduces visibility of CPAC candidates at XnAP level. This option means XnAP procedures for CPAC become similar to what is done for CHO preparation.

Option 1 is a lot simpler. When used, it still seems possible for the T-SN to consider availability of other CPAC candidates when admitting/refusing a CPAC candidate. The T-SN may wait for some time and decide based on the multiple XnAP messages that it may receive from the S-SN during this time window/period. The similar functionality is however easier to support in the second sub-option above,

In case the UE is configured with MRDC, the MN and SN interact in order to ensure that the overall configuration respects the UE capability limitations. It is recognised that for some of the UE capability limitations, the MN and SN negotiate how to split the available UE capabilities, mostly in a semi-static fashion. For example, inter-node procedures have been introduced by which the MN can set configuration restrictions for SN regarding band combinations (BCs) and feature sets. If the SN wishes to go beyond these restrictions, it can however initiate a re-negotiation procedure.

The MN is overall responsible and controls the overall/general UE configuration as well as the MCG configuration, while the SN controls the SCG configuration and the configuration of SN terminated RBs. Whenever the MN or SN wishes to modify some of their configurations, there may be a need to re-negotiate the semi-static UE capability split (i.e. a need to perform UE capability coordination).

As mentioned previously, R17 specifications have been extended to cover additional conditional reconfiguration cases, in particular covering:
a) SN initiated Change of PSCell involving change of SN
b) MN initiated Change of PSCell (CPC), which always involves change of SN
c) PSCell addition (CPA), which is always initiated by MN

While the UE is configured with conditional reconfiguration, the network may still wish to adjust the current configurations. Such reconfigurations may also affect the conditional reconfiguration to be applied at execution time. When the MN wishes to update the configuration, it may need to: coordinate with the SN to ensure UE capabilities remain respected; coordinate with the source SN and target SNs, as the configurations the UE has to apply at conditional reconfiguration execution require updating (due to change of MN and/or SN controlled configurations).

In R16, only intra-SN conditional reconfiguration is supported. Hence the issue is mainly something to be resolved in R17.

It is thought that the semi-static split of UE capabilities between the MN and T-SN is not necessarily the same as between the MN and S-SN i.e. it seems desirable that the MN can set different configuration restrictions for each SN, as the SCG configuration each SN supports may be different. On the other hand, setting configuration restrictions per individual SN seems to complicate procedures that could be alleviated if the MN is able to select some baseline split that is acceptable for all involved SNs.

When modifying the configuration of a UE in MRDC, UE capability coordination is supported according to one of the following options: separate capability coordination for each SN involved i.e. separate for S-SN and one or more T-SN; or common capability coordination where the MN applies the same SN configuration restrictions for all SN that are involved e.g. by signalling a single value acceptable for all SNs

The concerned UE capability coordination operation may apply in case the MN wants to reconfigure the configuration it controls, when the S-SN wants to reconfigure the configuration it controls as well as in cases one of the nodes merely wishes to renegotiate the UE capability split, not necessarily resulting in case of (pre-) configured configurations

When multiple SNs are involved in the capability coordination, this may be done by means of: a message/procedure in which information regarding multiple SNs is transferred; or multiple messages/procedures, each including information regarding a single SN. In this case, there may be means to indicate the procedures are related and should be handled/concluded together

The handling of the messages/procedures, as described above, applies for network interfaces as well as for the radio interface between the UE and network

The handling of the messages/procedures, as described above, applies for the request as well as the one or more related response message(s)

Embodiments provide a solution regarding how to handle the semi-static split of UE capabilities between MN and T-SN. At present, no other solutions are known. The embodiment offers several versions with differing complexity and flexibility as required in a particular case.

Errors with broadcast signalling may result in problematic behaviour for legacy UEs. Resolution of the problem is often rather complicated and often involves complete replacement of the erroneous signalling by a revision that only updated mobiles will receive, support and handle properly. This often results in significant specification changes and may render this size-critical signalling inefficient.

Replacement of the signalling is also required even if the information itself is sufficient or acceptable i.e. when there is just a need to stop legacy devices from performing certain functionality.

In an embodiment, the network broadcasts a field indicating some condition that the UE should meet in order to access the system to perform a certain feature for which information is broadcast.

The field can be a numerical value or similar and may indicate a specification version number that the UE complies with. For instance, this may be a version of a core specification or of a test site/profile.

In R17 of NR specifications support is introduced for Multicast and Broadcast Services (MBS). This may involve a significant amount of broadcast signalling, using general or MBS specific control channels. Given the limited time available to complete the specifications, it is not unlikely that an error will exist when the specifications are released. To avoid problems with UEs that are based on an erroneous specification version, the network may indicate that only UEs supporting MBS according to specification version 17.6.1 or later are allowed to access the network.

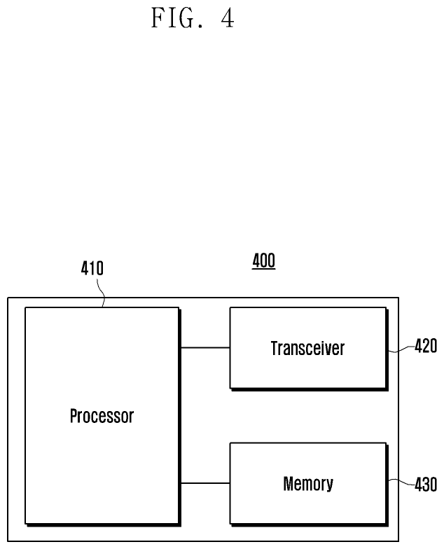

FIG. 4 illustrates an electronic device according to embodiments of the present disclosure.

Referring to the FIG. 4, the electronic device 400 may include a processor (or a controller) 410, a transceiver 420 and a memory 430. However, all of the illustrated components are not essential. The electronic device 400 may be implemented by more or less components than those illustrated in FIG. 4. In addition, the processor 410 and the transceiver 420 and the memory 430 may be implemented as a single chip according to another embodiment.

The electronic device 400 may correspond to electronic device described above. For example, the electronic device 400 may correspond to the terminal or the UE 100, 200 or 300 illustrated in FIGS. 1-3.

The aforementioned components will now be described in detail.

The processor 410 may include one or more processors or other processing devices that control the proposed function, process, and/or method. Operation of the electronic device 400 may be implemented by the processor 410.

The transceiver 420 may include a RF transmitter for up-converting and amplifying a transmitted signal, and a RF receiver for down-converting a frequency of a received signal. However, according to another embodiment, the transceiver 420 may be implemented by more or less components than those illustrated in components.

The transceiver 420 may be connected to the processor 410 and transmit and/or receive a signal. The signal may include control information and data. In addition, the transceiver 420 may receive the signal through a wireless channel and output the signal to the processor 410. The transceiver 420 may transmit a signal output from the processor 410 through the wireless channel.

The memory 430 may store the control information or the data included in a signal obtained by the electronic device 400. The memory 430 may be connected to the processor 410 and store at least one instruction or a protocol or a parameter for the proposed function, process, and/or method. The memory 430 may include read-only memory (ROM) and/or random access memory (RAM) and/or hard disk and/or CD-ROM and/or DVD and/or other storage devices.

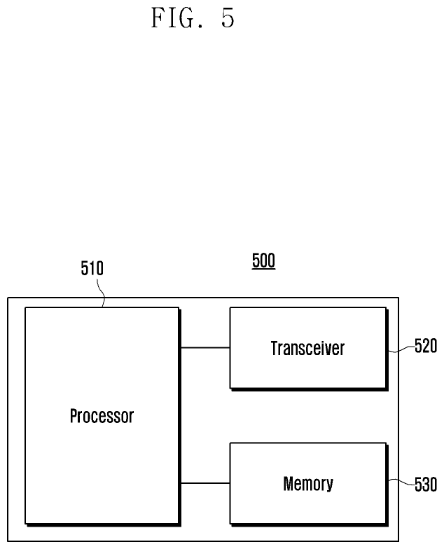

FIG. 5 illustrates a base station according to embodiments of the present disclosure.

Referring to the FIG. 5, the base station 500 may include a processor (or a controller) 510, a transceiver 520 and a memory 530. However, all of the illustrated components are not essential. The base station 500 may be implemented by more or less components than those illustrated in FIG. 5. In addition, the processor 510 and the transceiver 520 and the memory 530 may be implemented as a single chip according to another embodiment.

The base station 500 may correspond to the gNB described above. For example, the base station 500 may correspond to the gNB or RAN node 110, 120, 210, 220, 310, 320, 330 illustrated in FIGS. 1-3.

The aforementioned components will now be described in detail.

The processor 510 may include one or more processors or other processing devices that control the proposed function, process, and/or method. Operation of the base station 500 may be implemented by the processor 510.

The transceiver 520 may include a RF transmitter for up-converting and amplifying a transmitted signal, and a RF receiver for down-converting a frequency of a received signal. However, according to another embodiment, the transceiver 520 may be implemented by more or less components than those illustrated in components.

The transceiver 520 may be connected to the processor 510 and transmit and/or receive a signal. The signal may include control information and data. In addition, the transceiver 520 may receive the signal through a wireless channel and output the signal to the processor 510. The transceiver 520 may transmit a signal output from the processor 510 through the wireless channel.

The memory 530 may store the control information or the data included in a signal obtained by the base station 500. The memory 530 may be connected to the processor 510 and store at least one instruction or a protocol or a parameter for the proposed function, process, and/or method. The memory 530 may include read-only memory (ROM) and/or random access memory (RAM) and/or hard disk and/or CD-ROM and/or DVD and/or other storage devices.

Although this disclosure has been described with an exemplary embodiment, various changes and modifications may be suggested to one skilled in the art. It is intended that this disclosure encompass such changes and modifications as fall within the scope of the appended claims.

By this means, there is provided a general means to avoid legacy mobiles/UEs from accessing the network to perform certain features in a manner not involving potentially complicated re-design of the broadcast signalling that may also result in additional overhead.

At least some of the example embodiments described herein may be constructed, partially or wholly, using dedicated special-purpose hardware. Terms such as ‘component’, ‘module’ or ‘unit’ used herein may include, but are not limited to, a hardware device, such as circuitry in the form of discrete or integrated components, a Field Programmable Gate Array (FPGA) or Application Specific Integrated Circuit (ASIC), which performs certain tasks or provides the associated functionality. In some embodiments, the described elements may be configured to reside on a tangible, persistent, addressable storage medium and may be configured to execute on one or more processors. These functional elements may in some embodiments include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. Although the example embodiments have been described with reference to the components, modules and units discussed herein, such functional elements may be combined into fewer elements or separated into additional elements. Various combinations of optional features have been described herein, and it will be appreciated that described features may be combined in any suitable combination. In particular, the features of any one example embodiment may be combined with features of any other embodiment, as appropriate, except where such combinations are mutually exclusive. Throughout this specification, the term “comprising” or “comprises” means including the component(s) specified but not to the exclusion of the presence of others.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. A method performed by a user equipment (UE) in a wireless communication system, the method comprising:
receiving, from a first base station, logged measurement configuration information;
performing a first connection release procedure with the first base station;
transmitting, to a second base station, a first connection setup request message;
receiving, from the second base station, a first connection setup message; and
transmitting, to the second base station, a first connection setup complete message indicating that a measurement according to the logged measurement configuration information is not completed.

2. The method of claim 1, wherein the first base station operates according to a first radio access technology (RAT) and the second base station operates according to a second RAT.

3. The method of claim 1, wherein the connection setup complete message includes an indicator indicating whether a signalling-based minimization of drive tests (MDT) configuration is available.

4. The method of claim 1, further comprising:
performing a second connection release procedure with the second base station;
transmitting, to the first base station, a second connection setup request message;
receiving, from first second base station, a second connection setup message; and
transmitting, to the first base station, a second connection setup complete message.

5. The method of claim 4, wherein the second connection setup complete message indicates the measurement according to the logged measurement configuration information is not completed.

6. The method of claim 1, wherein logged measurement configuration information includes list information comprising at least one radio access technology (RAT) type.

7. The method of claim 6, wherein the list information indicates the at least one RAT type for a continuity of the measurement.

8. A user equipment (UE) in a wireless communication system, the UE comprising:
a transceiver; and
a controller configured to:
receive, from a first base station via the transceiver, logged measurement configuration information,
perform a first connection release procedure with the first base station,
transmit, to a second base station via the transceiver, a first connection setup request message,
receive, from the second base station via the transceiver, a first connection setup message, and
transmit, to the second base station via the transceiver, a first connection setup complete message indicating that a measurement according to the logged measurement configuration information is not completed.

9. The UE of claim 8, wherein the first base station operates according to a first radio access technology (RAT) and the second base station operates according to a second RAT.

10. The UE of claim 8, wherein the connection setup complete message includes an indicator indicating whether a signalling-based minimization of drive tests (MDT) configuration is available.

11. The UE of claim 8, wherein the controller is further configured to:
perform a second connection release procedure with the second base station.

12. The UE of claim 11, wherein the controller is further configured to:
transmit, to the first base station via the transceiver, a second connection setup request message,
receive, from first second base station via the transceiver, a second connection setup message, and
transmit, to the first base station via the transceiver, a second connection setup complete message.

13. The UE of claim 12, wherein the second connection setup complete message indicates the measurement according to the logged measurement configuration information is not completed.

14. The UE of claim 8, wherein logged measurement configuration information includes list information comprising at least one radio access technology (RAT) type.

15. The UE of claim 14, wherein the list information indicates the at least one RAT type for a continuity of the measurement.
